(19) United States
(12) Patent Application Publication
(10) Pub. No.: US 2006/0258334 A1
(43) Pub. Date: Nov. 16, 2006

(54) Wireless paging system

(75) Inventor: Joseph A. Tarallo, Flanders, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/129,999

(22) Filed: May 16, 2005

(51) Int. Cl. H04M 11/10

(52) U.S. Cl. 455/412.2; 455/466

(57) ABSTRACT

A wireless paging system allows a business to automatically page customers via the customers' existing mobile phones or other wireless devices, using an existing cellular telecommunications network, and without the need to provide a separate local-area paging network. The paging system includes a local, Internet-connected computer deployed at the business and a notification and scheduling program running on the computer. The notification program is directly or indirectly interfaced with the cellular network's short messaging service or the like, through the Internet or otherwise. If a customer has to wait upon arrival for a product and/or service, the customer's mobile phone number is entered into the notification program. Upon receiving data indicating that the product and/or service has become available, e.g., as entered into the local computer by employees, the notification program generates appropriate commands and/or instructions for having a notification message sent to the customer's wireless device.

### FIELD OF THE INVENTION

The present invention relates to wireless communications systems and, more particularly, to wireless paging and messaging services.

### BACKGROUND OF THE INVENTION

In certain service industry-related businesses, patrons have traditionally had to wait an indeterminate time period, either on or off premises, for a product to be ready, or for their turn in being served. For example, if a physician's office is running behind schedule, a patient may have to wait for a considerable period in the waiting room. Also, in the case of requesting expedited service for dry cleaning or shoe repair/shining, it may be uncertain as to exactly when the task will be completed. Customers either have to wait on site or rearrange their schedules for periodically checking back with the business via phone or in person.

Another place where customers frequently have to wait is at restaurants. If the restaurant is busy and the customer is without a reservation, the wait may be more than an hour, if a table becomes available at all. Additionally, even if the customer has a reservation, there may still be a wait if the restaurant is at capacity and/or experiencing slow turnover as parties linger over dessert and coffee. A number of restaurants have installed small-scale, local paging systems for notifying waiting customers when a table is available or when food is ready for pick-up. Usually the customer is handed a small pager, sometimes shaped as a beverage coaster, which has an operational range within the restaurant and the area immediately outside it. This limits the customers' mobility, since they may have to stay relatively close to the restaurant for being paged. Also, since the customers have to return the local-area pagers, businesses are generally not in favor of customers wandering too far off premises.

Various means exist for contacting people remotely. For example, wireless wide-area pagers can be used to provide the recipient with a telephone number or the like for calling back, or with some other type of notice. However, not many people use dedicated pagers, and it would be impracticable for busy restaurant workers to keep track of reservations and issue notifications on a piecemeal basis. While the popularity of traditional pagers is perhaps waning (e.g., those with one-way numerical messaging), most people now carry mobile phones, wireless personal digital assistants (“PDA”), or other wireless terminals for voice or data contact. However, as is the case with pagers, it is not practical for busy restaurant workers to take note of a patron's mobile phone number, track the reservation/waiting time, and then manually call the patron a short time before the table is ready.

### SUMMARY OF THE INVENTION

According to an embodiment of the present invention, a wireless paging system allows a business to automatically page or otherwise contact customers via wireless devices, e.g., mobile phones, that the customers likely already possess, using existing cellular telecommunications networks, and without the need to provide or implement a separate local or wide-area paging network. The wireless paging system includes a “local” computer deployed at the business place, e.g., a doctor's office, restaurant, or other service provider. Typically, the local computer will be an existing computer or terminal. A notification program is deployed on the local computer for carrying out data entry, scheduling, and notification functions. The local computer is operably connected to the Internet. The notification program is directly or indirectly interfaced to one or more existing cellular telecommunications networks, e.g., a mobile phone network, through the Internet, for purposes of sending messages or other notifications to the wireless devices using the cellular network's messaging functionality.

In operation, when a customer arrives at the place of business, if there is a significant wait or delay for a requested service and/or product, the customer's messaging identifier, e.g., a mobile phone number, text messaging address, or even e-mail address, is entered into the local computer through the notification program. The notification program includes data entry functionality for entering and storing the messaging identifier and other possible information in a database. Data entry may be partially or fully automated using a local-area wireless interface (e.g., infrared optical interface) between the local computer and wireless device. Once the customer information is entered, the notification program waits to receive “product data,” by which it is meant information relating to products and/or services, e.g., information indicating that the requested service and/or product is now available or will become available soon. For example, the notification program may include a scheduling module for scheduling or tracking the services offered by the business. When the product or service becomes available, an employee enters this information into the scheduling module. Based upon this information, the notification program automatically initiates access to the cellular network for sending a message or other notification to the customer's wireless device indicating that the service is ready or will be ready soon. The notification may be a text message, an automated voice message, an e-mail message, or the like.

The wireless paging system is useful, for example, for businesses that have a need to contact clients or customers automatically, by way of a text or automatic voice message, and without having to install a local area, private paging system. For example, instead of a restaurant having to provide a local area paging system for notifying customers when their tables are ready, including having to hand out dedicated paging devices (e.g., coaster-shaped pagers) that may become lost or damaged, the wireless paging system can be used to automatically contact customers over their own, existing mobile phones or other wireless devices.

### BRIEF DESCRIPTION OF THE DRAWINGS

The present invention will be better understood from reading the following description of non-limiting embodiments, with reference to the attached drawings, wherein below:

FIG. 1 is a schematic diagram of a wireless paging system according to an embodiment of the present invention;

FIG. 2 is a flowchart showing the operation of a messaging interface portion of the wireless paging system;

FIG. 3 is a flowchart showing how customer data is entered into the wireless paging system;

FIG. 4 is a flowchart showing a method for automatically alerting employees upon an unexpectedly long customer wait;

FIGS. 5 and 6 are flowcharts showing one possible method for determining when to contact waiting customers through the wireless paging system;

FIG. 7 shows a data correlation table according to one embodiment of the present invention; and

FIG. 8 is a schematic diagram of an alternative embodiment of the wireless paging system.

### DETAILED DESCRIPTION

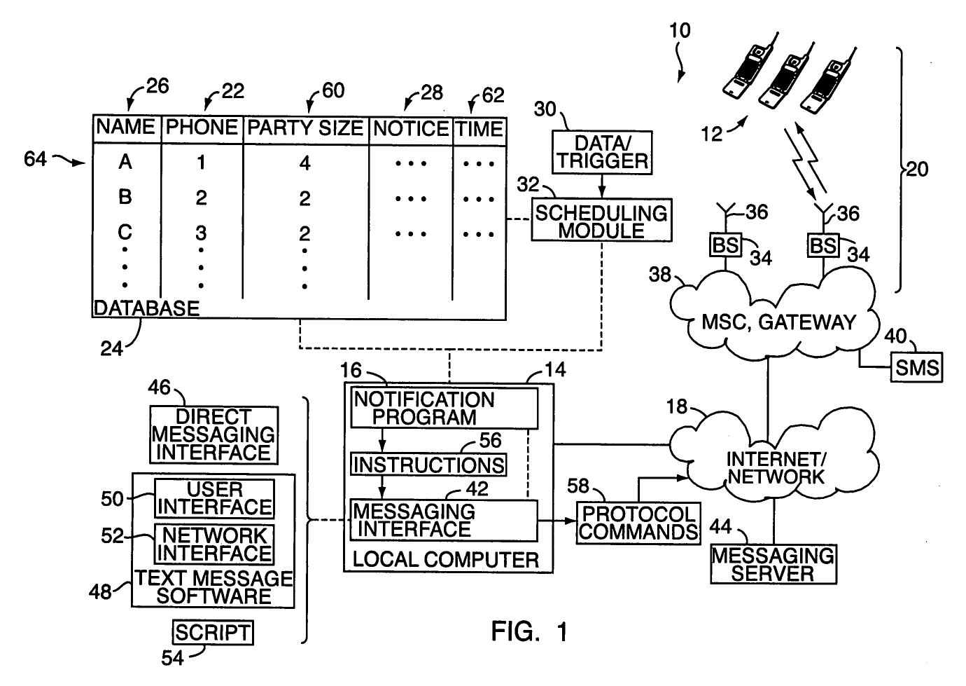

Referring to FIGS. 1-7, an embodiment of the present invention relates to a wireless paging system 10 allowing a business to automatically page or otherwise contact customers via wireless devices 12, e.g., mobile phones, that the customers likely already possess, using existing cellular telecommunications networks, and without the need to provide or implement a separate local or wide-area paging network. The growth of the wireless telecommunications industry has resulted in a high penetration rate, with a large percentage of the population subscribing to some type of wireless service and possessing a wireless device 12. Such wireless devices include, but are not limited to, conventional mobile phones, “high-end” or “3-G” mobile phone devices (e.g., those with high data transfer rates), conventional pagers, PDA-type mobile phones, specialty data devices (e.g., PC data cards), and other devices. Because of this high penetration, these existing devices are used as part of the wireless paging system 10.

The wireless paging system 10 includes a “local” computer 14 deployed at the business place, e.g., a doctor's office, restaurant, or other service provider. A notification program 16 runs on the computer 14 for carrying out data entry, scheduling, and notification functions. The local computer 14 is operably connected to the Internet or other network 18 in a standard manner, and is interfaced to one or more existing cellular telecommunications networks 20, e.g., a mobile phone network, for automatically sending messages or other notifications to the wireless devices 12.

In operation, when a customer arrives at a place of business, if there is a significant wait or delay for a requested service or product, the customer's messaging or other communications identifier 22, e.g., mobile phone number or messaging address, is entered into the local computer 14 through the notification program 16. The notification program 16 includes a user interface with data entry functionality for entering customer information into a database 24. Data entry may be fully or partially automatic through the use of a local-area wireless interface (e.g., infrared optical interface or the like) between the local computer and wireless device. The customer information includes the messaging identifier 22, and may include additional relevant information such as the customer's name 26 and the desired amount of notice 28 for contacting the customer prior to the service becoming available. Once the customer information is entered, the notification program 16 waits to receive product data 30 indicating that the service or product is now available or will become available soon. For example, the notification program 16 may include a scheduling module 32 for scheduling or tracking the services offered by the business. When the service in question becomes available, an employee enters corresponding product data 30 into the scheduling module 32 through the local computer 14 or through another computer, terminal, or device. This product data 30 serves as the “trigger” for initiating notification to the customer, and may be subjected to processing for determining if and/or when to send a notification to the customer's wireless device 12. The notification program 16 directly or indirectly accesses the cellular network 20 for having a message or other notification sent to the customer's wireless device 12 indicating that the service is ready or will be ready soon. The notification may be a text message, an automated voice message, an e-mail message, or the like.

As should be appreciated, the present invention is applicable to sending notifications relating to both products and/or services. As such, the term “product data,” as used herein, means information about products (meaning physical items), services (meaning actions to be performed), and/or combinations of the two (e.g., being served food at a restaurant). Typically, the product data will relate to the availability of requested products and/or services, where by “requested” it is meant a product and/or service that has been asked for but for which there is a wait or delay.

FIG. 1 shows the topography of a typical cellular network 20. The network 20 is geographically divided into a number of cells or sectors, which are typically contiguous and which together define the coverage area of the network. Each cell is served by a base station 34, which includes one or more fixed/stationary transceivers and antennae 36 for wireless communications with the wireless devices 12 that provide service to the network's users. The base stations 34 are in turn connected (either wirelessly or through land lines) to the rest of the network 38, which will typically include a network/Internet gateway and one or more mobile switching centers (“MSC”), each of which serves a particular number of base stations depending on network capacity and configuration. The mobile switching centers act as the interface between the wireless/radio end of the network 20 and a public switched telephone network or other network(s) 18, including performing the signaling functions necessary to establish calls or other data transfer to and from the wireless devices 12. The gateway acts as a physical and logical interface between the network 20 and the Internet or other network 18, for allowing communications there between. As should be appreciated, the present invention is not dependent on the configuration of a particular cellular network, and it will typically be implemented for use in conjunction with a number of different cellular networks 20, indirectly or directly through the Internet or otherwise. The various cellular networks may be configured differently from the network 20 shown in FIG. 1.

The cellular network 20 also includes a short messaging service (“SMS”) 40. The SMS 40 is an existing function of the cellular network 20 that allows users with properly configured wireless devices to send text messages to one another over the cellular network 20. To send a text message, the message is keyed into the user's wireless device 12 along with the messaging identifier 22 for contacting the recipient. As noted above, the messaging identifier may be the recipient's mobile phone number, or, depending on the particular network and SMS system, it may be a messaging address or number, e.g., a streamlined number or address designated for text messaging. The network 20 processes the text message for routing to the recipient. Message length is usually limited to 80-160 characters, and the recipient may need a compatible wireless device.

The local computer 14 is indirectly connected to the cellular network 20 through the Internet or other network 18. For initiating the generation of text messages or other notifications using the SMS 40, the local computer 14 is provided with an SMS interface means 42 for directly or indirectly interfacing with the cellular network's SMS system 40. The SMS interface means 42 works in conjunction with or as part of the notification program 16. Appropriate SMS interface means 42 include a direct interface 46, a commercially available text messaging software package 48, and/or a program or script 54 for interfacing with one or more Internet-based text messaging portals 44. The direct interface 46 would be a customized SMS access program configured for interfacing with the cellular network 20 and/or SMS system 40 in a direct manner using the protocols and/or command structures in place on the network 20 for accessing the SMS system 40 and generating and processing text messages. Depending on the particular cellular network 20, this might require a subscription or user account with the cellular network, and possibly specialized interface hardware.

Instead of an SMS direct access program 46, a commercial text messaging software package 48 could be used for interfacing with the SMS system 40. The text messaging software 48 would run on the local computer 14, and would include a user interface 50 and a network interface 52. The network interface portion 52 is configured for accessing the SMS system 40 over the Internet or other network 18, while the user interface 50 provides a streamlined, intuitive way for a user to access and utilize the functionality of the network interface 52, e.g., a graphical user interface or the like. In operation, instead of using a customized program for generating protocol messages or other commands or the like for directly accessing the SMS system 40, the user simply keys the messaging identifier 22, etc. into the user interface 50, and the network interface portion 52 automatically accesses the SMS system 40 according to its built-in program coding. The user interface 50, besides being configured for possible use by a person, would also be configured for operation by the notification program 16, e.g., the notification program 16 would be operably connected to the network interface 52, possibly through the user interface 50. As should be appreciated, a text messaging software program 48 would make it easier to implement the paging system 10, since the notification program 16 would only have to be configured for accessing the streamlined or simplified user interface 50, in lieu of providing a customized direct interface 46. Suitable text messaging software programs 48 include NotePager Pro™ and PageGate™ both available at www.notepager.com.

The SMS interface means 42 could also be a program or script 54 for interfacing with one or more existing Internet-based text messaging portals 44. Some Internet-based portals are specific to a particular wireless service provider and can only be used to send messages to subscribers of the particular service provider. However, certain general-purpose portals allow for text messaging to wireless terminals independent of the wireless service provider. Examples include www.smseverywhere.com and www.teleflip.com. The script or program 54 would operate on the local computer 14 in conjunction with the notification program 16, and would be configured to access the Internet-based text messaging portal(s) 44 for causing text messages to be sent to the wireless devices 12. Alternatively, the script or program 54 could be configured to interface with an existing e-mail program or server on the local computer 14 (e.g., Microsoft Outlook™) for sending appropriately configured e-mail messages to a text messaging e-mail address. Text messaging e-mail addresses are maintained by certain cellular network service providers and/or text messaging portals 44 for allowing users to send text messages using an e-mail message. To initiate the sending of a text message, an e-mail message is sent to the particular e-mail address. Typically, the e-mail address will have a format similar to the following: (messaging_identifier)@domain_name.com. As should be apparent, the body of the e-mail message forms the message text, the e-mail message subject the text message subject, and the “messaging_identifier” portion of the e-mail address the messaging identifier of the desired recipient's wireless device. Example addresses include (messaging_identifier)@vtext.com and (messaging_identifier)@teleflip.com. The former is specific to the Verizon® network, while the latter is not network specific. Instead, the service looks up the messaging identifier in a database for determining the messaging identifier's service provider and, correspondingly, the manner in which to send a text message.

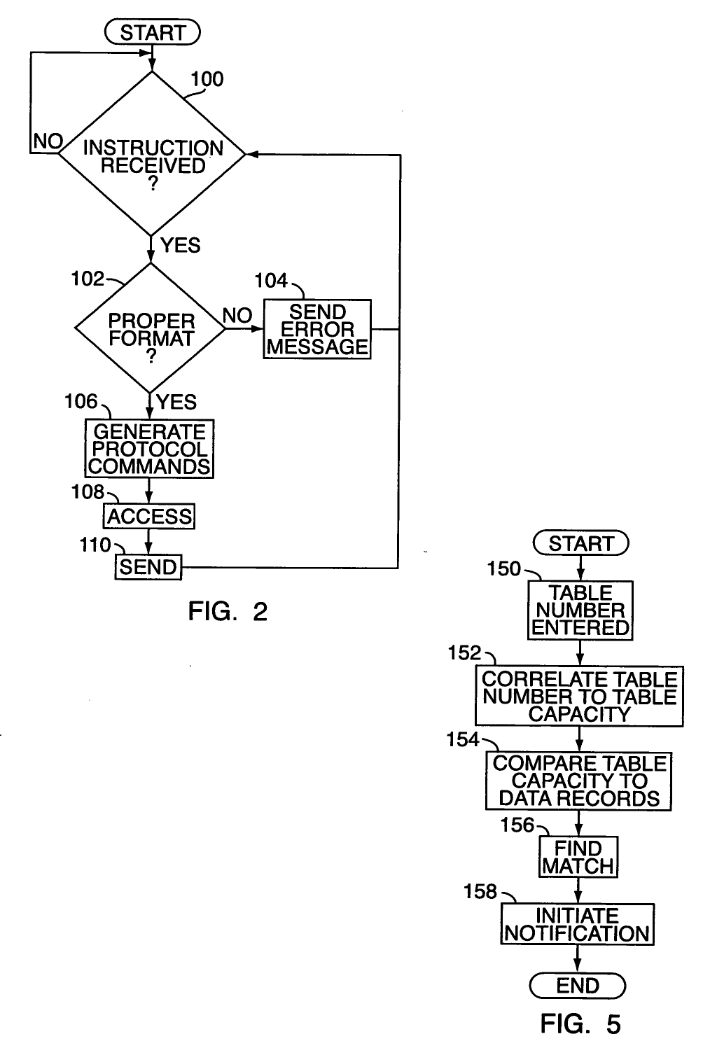

FIG. 2 shows the general operation of the SMS interface means 42. At Step 100, the SMS interface 42, running on the local computer 14 in conjunction with or as part of the notification program 16, waits for one or more instructions 56 from the notification program 16. The instruction(s) 56 will typically include the messaging identifier 22 of the customer that is to be notified, and the text of the message to be sent. The instruction 56 may also include one or more commands or the like for controlling the SMS interface 42. At Step 102, the SMS interface 42 optionally checks whether the instruction 56 is properly formatted and contains the requisite information. If not, at Step 104, an error message is sent to the notification program 16. If the instruction 56 is properly configured, at Step 106 the SMS interface 42 generates one or more protocol commands 58 for accessing the SMS system 40, if needed, depending on the particular manner in which the SMS system 40 is accessed. By “protocol commands,” it is meant whatever electronic instructions, signals, or transmissions are required for accessing the SMS system 40, directly or indirectly, for causing messages to be sent to the wireless devices 12. It may also be necessary to format the messaging identifier 22 and message. At Step 108, the cellular network 20 and/or the Internet or other networks 18 are accessed. Then, at Step 110, the SMS interface 42 sends the protocol commands 58, messaging identifier 22, and message. Depending on the particular SMS interface 42, Steps 106-110 may be performed in a different order.

If the SMS interface 42 is a customized SMS direct access program 46, the protocol commands might include a subscription account name and password along with one or more instructions or signals indicating that the message is to be sent to the wireless device identified by the messaging identifier 22. If the SMS interface 42 is a text messaging software program 48, similar protocol commands will typically be issued. However, this would done according to the text messaging software's existing programming, with the notification program 16 being configured to produce instructions for controlling the text messaging software program 48 through its user interface 50 or otherwise. If the SMS interface 42 is a script 54 for use with an Internet-based text messaging portal 44, the protocol commands would be the instructions or signals required for sending messages using the portal 44, according to its particular configuration. For example, for using www.smseverywhere.com, the script 54 would automatically perform one or more of the following functions/steps: access the www.smseverywhere.com website; log on to the service through the membership page (membership is optional but would provide unlimited messaging); input the particular messaging identifier 22 into the “Send To” field or the equivalent; input a subject into the “Subject” field or the equivalent; input a message into the “Message” field or the equivalent; perform a check that the maximum number of characters has not been exceeded; and initiate the “Send Now” function to send the message to the wireless device 12 associated with the messaging identifier 22.

In a cellular network 20 where message delivery verification is available, the paging system 10 could be notified that the message was delivered successfully and also whether or not it was accessed. In either case, if not, business employees could be alerted, or the message could be re-sent.

The wireless paging system 10 allows the use of standard commercial wireless devices 12 as a substitute for a local paging system or to provide new paging or other capabilities without having to install a wireless system separate from existing commercial wireless systems 20. Instead of providing customers with dedicated, local-area pagers or the like for notification over a local paging system, customers are notified via wireless devices 12 that they likely already possess, such as mobile phones. Such an operation could be performed manually, by way of an employee calling the customer when the service is ready. However, doing so would become quickly impractical in a large business during busy times. As such, the wireless paging system 10 notifies customers automatically, and according to improved and automated scheduling functionality by way of the scheduling module 32 and database 24.

The scheduling module 32 and database 24 will now be further described with respect to an exemplary implementation for use in the food service industry, e.g., a restaurant or similar business. While these components might be implemented in a slightly different manner for other businesses, the overall operation and functionality would be generally the same. The wireless paging system 10 is by no means limited for use by restaurants or the like, but for illustration purposes this description will be followed through herein.

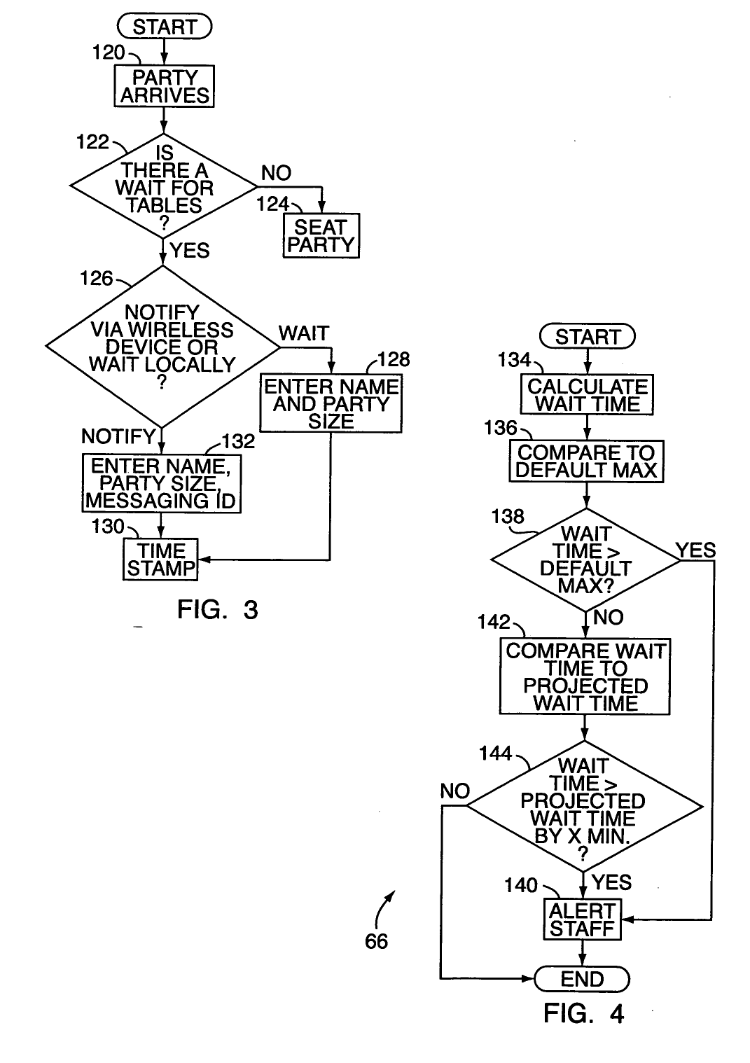

FIG. 3 shows how the scheduling module 32 and database 24 operate for entering information into the database 24 when parties arrive, within the context of relevant events as they typically occur at a fine dining restaurant. For example, at Step 120, a party of one or more patrons arrives at the restaurant, hoping to, e.g., secure a table for the chefs five course tasting menu as recently featured in the local newspaper's dining guide section. At Step 122, the host, hostess, or maitre d' determines whether or not the party will have to wait for a table. If not, at Step 124, the party is seated. If so, at Step 126 the party is asked whether it would like to wait in a nearby waiting area, or if it would like to be notified via wireless device when a table is ready. If there is only a very short wait (e.g., 5-10 minutes), the party might be directed to wait nearby, with a vocal page when their table is ready, to avoid having the party disadvantageously “wander off.” If the party chooses to wait nearby, it could be the case that the wait staff would track table availability for such parties manually. However, especially for long waits (which would be difficult for the wait staff to track manually), table availability would be tracked automatically through the system 10. In such a case, at Step 128, the party's name 26 would be entered into the database 24 through the scheduling module 32, along with the party size 60 and any other relevant information such as whether the party would prefer a smoking or non-smoking table. No messaging identifier 22 or notice 28 would be entered, with the scheduling module 32 using this as an indication that the party is waiting locally, and will not be notified via wireless device 12. At Step 130, the scheduling module 32 would optionally automatically add a time stamp or time entry notation 62 to the database 24 as an indication of when the party arrived. As should be appreciated, this combined party information (name, party size, time stamp, etc.) would comprise, in effect, a data record 64 in the database 24, e.g., a set of related, associated data or information. If the party chose to be notified by wireless device 12, at Step 132 the wait staff would enter into the database 24 the party's name 26, messaging identifier 22, party size 60, and, optionally, the desired amount of notice 28. Again, this information in combination would form a data record 64 in the database 24. At Step 130, the scheduling module 32 would optionally automatically add a time stamp 62 indicating when the party had arrived.

With reference to FIG. 4, the time stamp 62 could be used as a “backup” means for identifying instances where a party has waited longer than expected. For example, the scheduling module 32 could periodically run a “time check” subroutine 66 for each data record 64. At Step 134, the scheduling module 32 determines the party's wait time by calculating the difference between the current time and the time stamp 62. At Step 136, the wait time is compared to a default value representing a maximum desired wait time as determined by the restaurant. At Step 138, it is determined whether the wait time has exceeded the default maximum value. If so, the scheduling module 32 alerts the wait staff at Step 140. If not, at Step 142, the wait time is compared to a projected wait time as previously entered by the wait staff or as otherwise determined. (Typically, the wait staff at a restaurant will give a party some indication of the projected wait time, which could be entered into the database 24 along with the party's name, etc.) At Step 144, the scheduling module 32 determines whether the actual wait time has exceeded the projected wait time by some predetermined reasonable value “X,” e.g., fifteen minutes. If so, the wait staff is alerted as at Step 140. If not, the time check subroutine 66 is exited until its next periodic implementation.

As noted above, for use in determining when to notify a waiting party, product data 30 is entered into the scheduling module 32. In the context of a restaurant, the data 30 will typically be information relating to which tables in the restaurant have become available for new patrons. The scheduling module 32 is configured to correlate this data 30 to the waiting parties' data records 64 stored in the database 24. For example, with reference to Step 150 in FIG. 5, when a current party vacates a table, a member of the wait staff accesses the notification program 16 on the local computer 14, and enters data 30 indicating that a particular table number has just been vacated. The notification program 16 includes a lookup table or other data array in the database 24 correlating table numbers to their respective capacity. As such, at Step 152, the scheduling module 32 accesses the lookup table to correlate the vacated table number with that table's capacity. The wait staff could also indicate whether the table is currently available or is yet to be bussed, with the scheduling module 32 assuming that a table according to the latter will be available for seating a new party within a certain time period. At Step 154, the scheduling module 32 compares the capacity of the newly available table to the waiting parties' data records 64 to find a suitable match at Step 156, e.g., to determine to which party to assign the vacant table. Then, at Step 158, the notification program 16 initiates the issuance of a message or other notification to the matched party.

For notification, if the party chose to wait at Step 126 (FIG. 3), or if no one in the party was carrying a wireless device 12, the notification program 16 alerts the wait staff that a table has become available, for manual or automatic (e.g., computer generated) issuance of a auditory local-area page. For example, the notification program 16 could generate an appropriate “pop up” message or window on the local computer's display, including the party name, size, and available table. If the party chose to be notified by wireless device at Step 126, the notification program 16 initiates the sending of an appropriate text message or the like, as described above. Optionally, the notification program 16 could also alert the wait staff that the party's table has become available. For example, the notification program 16 could maintain a list on the local computer's display identifying the parties to whom notification messages have been sent. Then, when each party arrived to be seated, the wait staff would delete that entry from the table, with the notification program 16 automatically deleting the corresponding record 64 from the database 24. Optionally, the notification program 16 could periodically check the list of notified parties, and for any entries not deleted within a certain time period, re-send a notification via wireless device or otherwise.

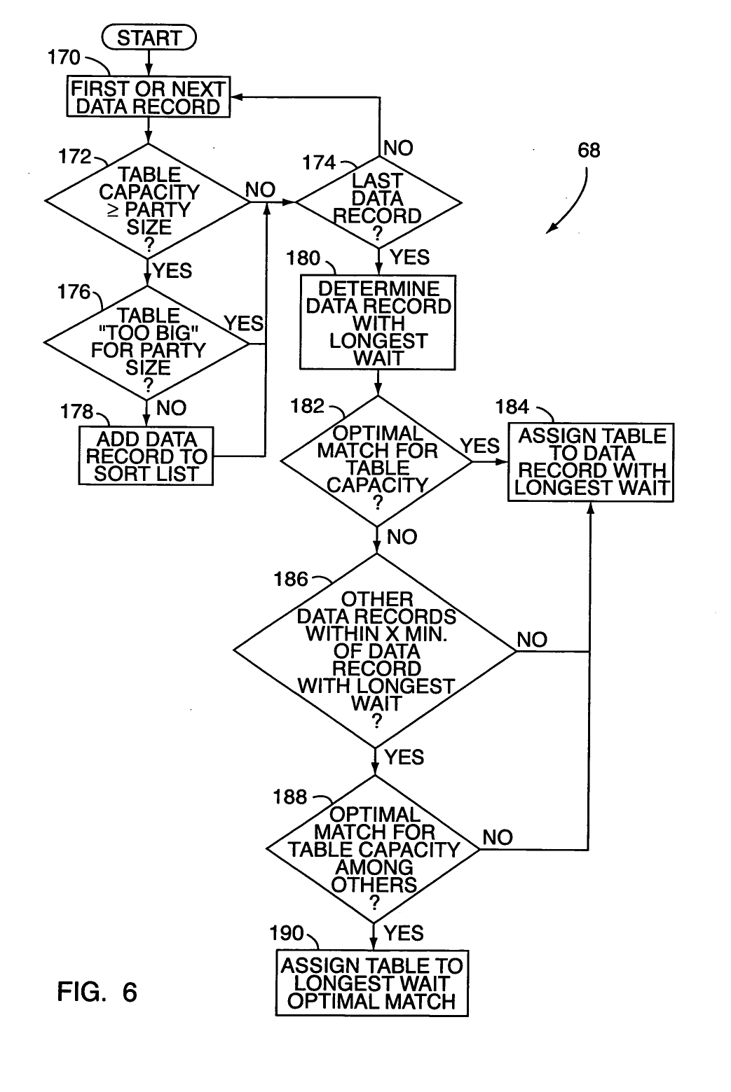

As indicated, the scheduling module 32 determines how to assign newly vacated tables to waiting parties in Steps 154 and 156. This can be done in a number of different ways, depending on the particular manner in which the restaurant is operated, and according to a number of possible database querying and sorting options. FIG. 6 shows one possible data sorting subroutine 68 executed by the scheduling module 32 for determining how to assign tables. (Of course, any number of other subroutines are possible.) First, the party data records 64 are sorted to form a sort list. To do so, at Step 170, the subroutine proceeds to the first data record 64 in the database 24, or to the next data record if one or more data records have already been sorted. At Step 172, for the data record being currently accessed, it is determined whether the newly available table has a large enough capacity for the party size 60. If not, the subroutine proceeds to Step 174 to determine if there are any remaining data records 64 to sort. From Step 174, if data records remain to be sorted, the subroutine proceeds to the next data record back at Step 170.

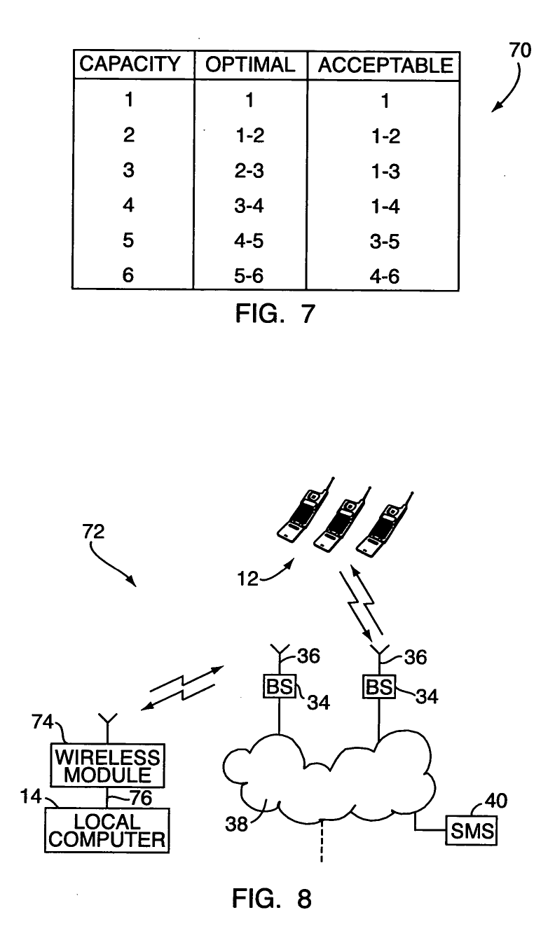

Back at Step 172, if the table has a large enough capacity for the party size, the subroutine determines at Step 176 if the table is “too big” for the party size. For example, the restaurant might have a policy that a very large table will never be assigned to a very small party, to avoid wasting table space. An example listing of one possible table capacity configuration 70 is shown in FIG. 7, where by “optimal” it is meant the best match between party size and table capacity for optimizing the use of table space, and where by “acceptable” is it meant a match that utilizes table space in a less optimized, but still acceptable manner. For example, as indicated in FIG. 7, a six person-capacity table would never be assigned to less than four patrons, less preferably assigned to four patrons, and most preferably assigned to five or six patrons. (Again, it should be remembered that this is just one possible configuration based on one possible restaurant policy, as an example.)

If the newly available table is determined not to be “too big” for the party size at Step 176, the current data record is added to the sort list at Step 178. If the table capacity is deemed too large, then the current data record is not added to the sort list. In either case, the subroutine 68 continues to Step 174 for a determination of whether or not the current data record is the last data record. If not, the subroutine continues back at Step 170. If it is, all the data records 64 have been sorted, and the sort list is complete. The subroutine 68 continues to Step 180 to determine the longest waiting party on the sort list, e.g., it finds the data record 64 that has the earliest time stamp 62. At this point, the scheduling module 32 may simply assign the newly available table to the longest waiting party. However, it may be possible to further better utilize table capacity by further processing the sort list. To do so, as one possible example, at Step 182 the subroutine checks to see if the longest waiting party is an optimal match to the newly available table. Again, this is done by referring to a data correlation table such as the one shown in FIG. 7, comparing table capacity to party size. For example, if the newly available table can seat four patrons, an optimal party size for seating at that table would be three or four persons.

If the longest waiting party is an optimal match to the table capacity, then the table is assigned to the longest waiting party at Step 184. If not, the subroutine 68 goes on to assign the table to a shorter-waiting, optimally-matched party, but only if that party arrived within a reasonably short time of the longest waiting party. For example, for optimally utilizing table capacity, it may make more sense to seat a party of four at a four-seat table ahead of a party of one, if the party of four arrived just after the party of one. On the other hand, if the party of one has been waiting for a significantly longer time, restaurant policy might dictate that that party be seated first, even if at a large-capacity table. So, at Step 186, the subroutine determines if there are any parties from the sort list that arrived within “X” minutes of the longest waiting party, where “X” is a variable assigned a value according to restaurant policy. For example, X might be from five to ten minutes. If not, the table is assigned to the longest waiting party at Step 184. If so, the subroutine then checks, at Step 188, whether any of those other parties provide an optimal match to the capacity of the newly available table. If not, the table is assigned to the longest waiting party at Step 184. If so, at Step 190, the table is instead assigned to the longest-waiting party among the optimized matches.

Instead of entering table or other trigger data 30 into the database 24 by accessing the notification program 16 on the local computer 14, employees could instead enter data using remote or other terminals. For example, each staff member could be provided with access to a wireless PDA operably wirelessly connected to the local computer 14. Also, instead of table or other information 30 being manually entered into the system 10 by employees, it could be entered automatically, e.g., from a cash register system based on when a table's check is paid, or by computer-based detection means such as video cameras.

The notification program 16, including the scheduling module 32, may be provided with a number of additional functions for scheduling and modifying customer notifications. For example, functionality could be provided for staff members to delete or modify data records, to change table configurations, to enter and maintain advance reservations, to issue manual notifications, or the like. The notification program 16 could be provided with a graphical user interface.

To summarize the operation of the paging system 10 with respect to a concise example, upon first arriving at a restaurant, a customer inquires about a table and is told there will be a waiting period. The customer gives the host his or her mobile phone number and some indication of how much notice the customer would like for table availability. Then, the host enters the phone number 22 and notice interval information 28 into the database 24 through the notification program 16. Based on table availability information 30, either automatically or manually provided to the system, the system 10 initiates contact with the customer's mobile phone 12. An example would be for the system to initiate an SMS message to the customer's mobile station 12 stating something like “Your table will be ready in 5 minutes.” An alternative is for the system to send a pre-recorded or computer-generated voice message to the customer. This system could be implemented for other businesses, such as medical offices. One way of providing the type of paging/messaging capability described in the above would be to build custom hardware and software. However, it is also possible to leverage existing hardware and software, and the implementation described above uses standard, readily available computer equipment and networks. Some customization can be done for the particular application, such as the creation of queues, or automatically recognizing triggers that would necessitate a page or message being sent to the customer.

One embodiment of the present invention may be characterized as a method for communicating with or otherwise contacting a wireless device (e.g., a customer's mobile phone 12) over a network (e.g., the cellular network 20), as carried out by the notification program 16. First, the notification program receives product data, e.g., information about the availability of a requested product and/or service. For example, an employee may enter into the computer 14 information indicating that a particular table has become available. Then, based on the product data, the notification program 16 automatically sends a notification or other message to the wireless device. The received data may also be automatically processed for determining whether to send a notification to the wireless device. Such processing may include correlating time stamp and other customer data to the received data (e.g., data indicating that a product or service has become available), and/or processing the received data and/or customer data with respect to various business policies, as implemented in an algorithm (see, e.g., FIG. 6 and associated description).

FIG. 8 shows an alternative embodiment 72 of the paging system. Here, instead of interfacing with the cellular network 20 over the Internet or other network 18 (see FIG. 1), the paging system 72 would include a wireless module 74 connected to the local computer 14. The wireless module 74 would have the same or similar functionality as a typical wireless device 12, such as RF transceivers and antenna for communicating with the base stations 34, and functionality for receiving and sending text messages or the like. Additionally, the wireless module 74 would have a data/power bus 76 for receiving electrical power from the computer and for exchanging data with the computer, e.g., an IEEE 1394 interface. The local computer 14 and wireless module 74 would also have intercommunicating software programs enabling the messaging interface 42 to communicate with and control the wireless module 74. As should be appreciated, although FIG. 8 shows the wireless module 74 and customer wireless devices 12 communicating through one cellular network, it is also the case that the wireless module 74 and the wireless devices 12 could be serviced by different cellular networks and/or service providers, with the different networks intercommunicating in a standard matter through the Internet, a public switched telephone network, or otherwise.

Since certain changes may be made in the above-described wireless paging system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of communicating with a wireless device over a network, the method comprising the steps of:
receiving product data; and
automatically sending a notification to the wireless device over the network based on the product data.

2. The method of claim 1 further comprising the step of:
automatically processing the product data for determining if to send the notification.

3. The method of claim 2 wherein:
the product data relates to the availability of a requested product and/or service;
the method further comprises the step of storing time stamp data relating to when the product and/or service was requested; and
the step of processing the product data comprises correlating the product data to the time stamp data.

4. The method of claim 3 wherein the step of correlating the product data to the time stamp data comprises determining priority between different requests for the product and/or service.

5. The method of claim 1 wherein:
the network is a wireless network having a short messaging service (SMS); and
the notification is a text message sent using the SMS.

6. The method of claim 5 wherein the step of sending the text message comprises issuing at least one SMS instruction to the SMS over the wireless network.

7. The method of claim 5 wherein the step of sending the text message comprises issuing at least one SMS instruction to the SMS through a computer network connected to the wireless network.

8. The method of claim 5 wherein the step of sending the text message comprises issuing at least one instruction to a text messaging software program interfaced with the SMS through a computer network connected to the wireless network.

9. The method of claim 5 wherein the step of sending the text message comprises issuing at least one instruction to a messaging server interfaced with the SMS through a computer network connected to the wireless network.

10. The method of claim 9 wherein the at least one instruction is issued by way of an e-mail message sent to the messaging server.

11. The method of claim 5 further comprising the step of:
automatically processing the product data for determining if to send the text message.

12. The method of claim 11 wherein:
the product data relates to the availability of a requested product and/or service;
the method further comprises the step of storing time stamp data relating to when the product and/or service was requested; and
the step of processing the product data comprises correlating the product data to the time stamp data.

13. The method of claim 12 wherein the text message contains information relating to the availability of the requested product and/or service.

14. A method of communicating with a wireless device over a network, the method comprising the steps of:
receiving data;
automatically determining whether to send a notification to the wireless device based on the received data; and, if so,
automatically sending a notification to the wireless device over the network.

15. The method of claim 14 wherein:
the received data relates to the availability of a requested product and/or service;
the method further comprises the step of storing time stamp data relating to when the product and/or service was requested; and
the step of determining whether to send the notification comprises correlating the received data to the time stamp data.

16. The method of claim 15 wherein the step of correlating the product data to the time stamp data comprises determining priority between different requests for the product and/or service.

17. The method of claim 14 wherein:
the network has a short messaging service (SMS); and
the method further comprises the step of, upon determining to send the notification, automatically issuing at least one SMS instruction to the SMS for having a text message sent to the wireless device.

18. A method of communicating with a wireless device over a network, the method comprising the steps of:
storing customer data;
receiving product data;
correlating the product data to the customer data; and
automatically sending a notification to the wireless device over the network based on the correlation.

19. The method of claim 18 wherein:
the product data relates to the availability of a requested product and/or service;
the customer data includes time stamp data relating to when the product and/or service was requested; and
the step of correlating the product data to the customer data comprises determining priority between different requests for the product and/or service based at least in part on the time stamp data.

20. The method of claim 18 wherein:
the network includes a short messaging service (SMS); and
the notification is a text message sent over the SMS.
